(19) United States
(12) Patent Application Publication
(10) Pub. No.: US 2026/0134351 A1
(43) Pub. Date: May 14, 2026

(54) COLLECTIVE ARTIFICIAL INTELLIGENCE CONSENSUS AND ANTI-HERDING SYSTEM

(71) Applicant: George William Bickerstaff, III, Greenwich, CT (US)

(72) Inventor: George William Bickerstaff, III, Greenwich, CT (US)

(21) Appl. No.: 19/444,257

(22) Filed: Jan. 9, 2026

(51) Int. Cl. G06N 20/00; G06F 18/22

(52) U.S. Cl. CPC G06N 20/00; G06F 18/22

(57) ABSTRACT

A collective artificial intelligence consensus and anti-herding system detects correlated agent behavior at execution time, dynamically rebalances agent influence, enforces diversity constraints prior to execution, and generates auditable consensus artifacts, enabling stable and governable multi-agent artificial intelligence systems.

### TECHNICAL FIELD

The present invention relates to collective artificial intelligence systems and, more particularly, to systems and methods for execution-time governance of consensus formation among multiple artificial intelligence agents through correlation detection, anti-herding enforcement, and auditable control mechanisms.

### BACKGROUND

Collective artificial intelligence systems increasingly rely on multiple autonomous or semi-autonomous agents to generate predictions, recommendations, or decisions. These systems may include ensembles, federated inference frameworks, or distributed decision-making agents operating concurrently. Aggregation of multiple agent outputs is intended to improve robustness, accuracy, and resilience.

However, when agents rely on overlapping data sources, similar architectures, or shared feedback signals, correlated behavior may arise. This correlated behavior, commonly referred to as herding, can cause aggregation mechanisms to amplify shared errors rather than mitigate systemic risk. In systems that execute decisions in real time, post-hoc analysis is insufficient to prevent irreversible or harmful actions.

Existing consensus mechanisms typically aggregate agent outputs without detecting or mitigating correlated behavior at execution time. There is therefore a need for a technical system that detects correlated agent behavior prior to execution, dynamically adjusts agent influence, enforces diversity constraints, and generates auditable records of collective decision behavior.

### SUMMARY OF THE INVENTION

The invention provides a collective artificial intelligence consensus and anti-herding system configured to evaluate agent outputs for correlated behavior prior to execution. The system computes correlation and similarity metrics, generates herding signals when violation thresholds are exceeded, dynamically rebalances agent influence, and enforces diversity constraints through a consensus gate.

By embedding anti-herding enforcement directly into the execution pathway, the system improves collective decision stability, reduces correlated failure risk, and enables deterministic, auditable governance of multi-agent artificial intelligence systems.

### DEFINITIONS

### Agent

An autonomous or semi-autonomous artificial intelligence model configured to generate an output.

### Aggregation Engine

A system component that combines weighted agent outputs into a collective result.

### Consensus Audit Artifact

A cryptographically verifiable data structure recording agent outputs, correlation metrics, influence weights, violation thresholds, and execution outcomes.

### Consensus Gate

A control point that determines whether an aggregated result may proceed to execution.

### Correlation Metric

A computed measure of similarity or statistical dependence between agent outputs.

### Herding Signal

A machine-generated indicator that correlated behavior exceeds a violation threshold.

### Influence Weight

A numerical value representing the relative contribution of an agent to consensus formation.

### Rebalancing Controller

A component that adjusts influence weights to mitigate correlated behavior.

### Similarity Metric

A quantitative measure used to assess alignment between agent outputs.

### Violation Threshold

A predefined boundary value indicating unacceptable correlation or insufficient diversity.

### BRIEF DESCRIPTION OF THE DRAWINGS

FIG. 1 illustrates multi-agent input collection.

FIG. 2 illustrates correlation and herding detection.

FIG. 3 illustrates consensus formation with anti-herding control.

FIG. 4 illustrates execution interception and rebalancing.

FIG. 5 illustrates audit artifact generation and replay.

### DETAILED DESCRIPTION

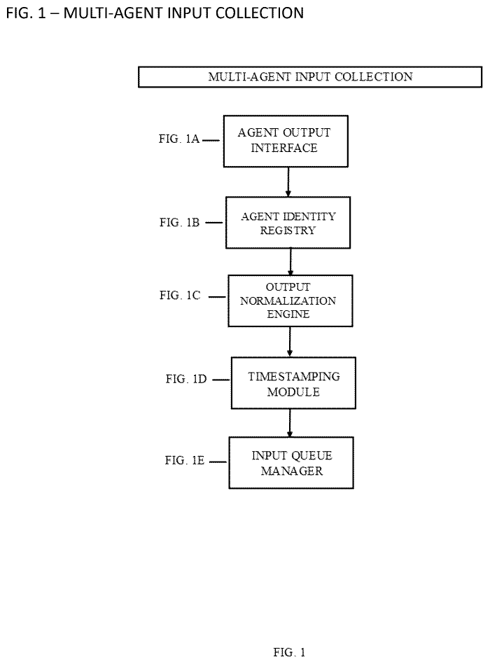

### FIG. 1—Multi-Agent Input Collection

FIG. 1 illustrates collection of outputs from a plurality of artificial intelligence agents prior to consensus evaluation. Each agent independently generates a candidate output. The collected outputs are normalized, timestamped, and queued for processing.

### FIG. 1A—Agent Output Interface

FIG. 1A depicts an interface configured to receive candidate outputs from multiple agents. The interface validates output structure and format. Validated outputs are forwarded for normalization.

### FIG. 1B—Agent Identity Registry

FIG. 1B illustrates a registry that maintains identifiers and attributes for participating agents. The registry supports traceability and attribution of agent outputs. Agent identity information is referenced throughout consensus evaluation.

### FIG. 1C—Output Normalization Engine

FIG. 1C shows an engine that converts agent outputs into a canonical, machine-readable format. Normalization ensures comparability across heterogeneous agent outputs. Representation bias is reduced prior to analysis.

### FIG. 1D—Timestamping Module

FIG. 1D depicts a module that assigns timestamps to agent outputs upon receipt. Timestamps preserve temporal ordering of outputs. Temporal data supports correlation analysis.

### FIG. 1E—Input Queue Manager

FIG. 1E illustrates a queue manager that orders agent outputs for evaluation. The manager controls throughput and sequencing. Outputs remain queued until consensus processing begins.

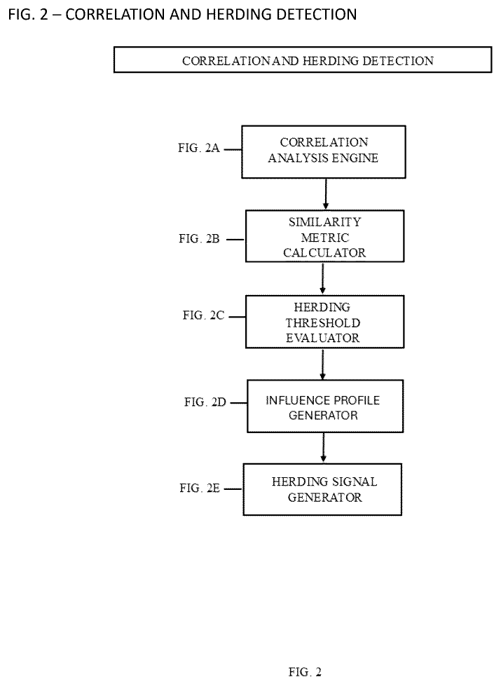

### FIG. 2—Correlation and Herding Detection

FIG. 2 illustrates detection of correlated behavior among agent outputs. Correlation and similarity metrics are computed across agents. Herding conditions are identified prior to execution.

### FIG. 2A—Correlation Analysis Engine

FIG. 2A depicts an engine that computes correlation metrics between agent outputs. Metrics quantify statistical dependence or alignment. Results are forwarded for threshold evaluation.

### FIG. 2B—Similarity Metric Calculator

FIG. 2B illustrates a calculator that computes similarity values between outputs. High similarity values indicate potential herding. Calculated values inform mitigation decisions.

### FIG. 2C—Herding Threshold Evaluator

FIG. 2C shows a component that compares correlation metrics to predefined violation thresholds. Threshold breaches indicate unacceptable correlated behavior. Breaches trigger herding signal generation.

### FIG. 2D—Influence Profile Generator

FIG. 2D illustrates generation of influence profiles for each agent. Profiles represent relative contribution to consensus outcomes. Profiles are updated dynamically during enforcement.

### FIG. 2E—Herding Signal Generator

FIG. 2E depicts a generator that produces herding signals when thresholds are exceeded. Herding signals indicate non-diverse agent behavior. Generated signals initiate rebalancing.

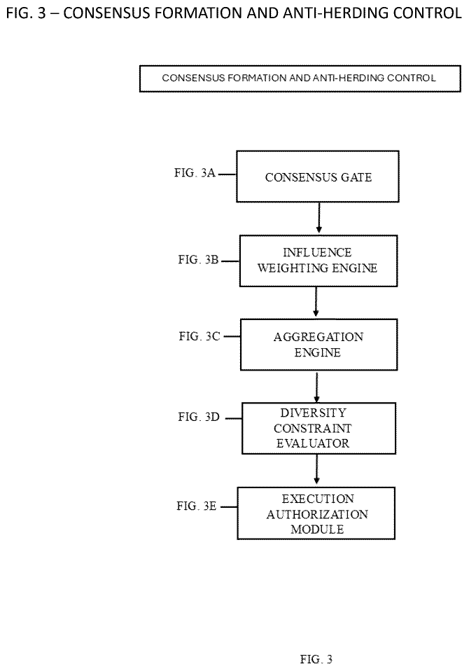

### FIG. 3—Consensus Formation and Anti-Herding Control

FIG. 3 illustrates consensus formation with integrated anti-herding enforcement. Agent influence is dynamically adjusted prior to aggregation. Aggregated results are evaluated before execution.

### FIG. 3A—Consensus Gate

FIG. 3A depicts a gate that controls whether aggregated outputs may proceed to execution. The gate enforces diversity constraints. Execution is permitted only when constraints are satisfied.

### FIG. 3B—Influence Weighting Engine

FIG. 3B illustrates an engine that assigns and adjusts influence weights for agent outputs. Correlated agents are down-weighted. Adjusted weights are applied prior to aggregation.

### FIG. 3C—Aggregation Engine

FIG. 3C shows an engine that aggregates weighted agent outputs. Aggregation produces a collective output. The output reflects balanced agent contributions.

### FIG. 3D—Diversity Constraint Evaluator

FIG. 3D illustrates evaluation of diversity constraints on aggregated results. Constraints ensure heterogeneity among contributing agents. Violations trigger rebalancing.

### FIG. 3E—Execution Authorization Module

FIG. 3E depicts a module that authorizes execution of compliant consensus results. Authorization occurs after evaluation. Approved results proceed downstream.

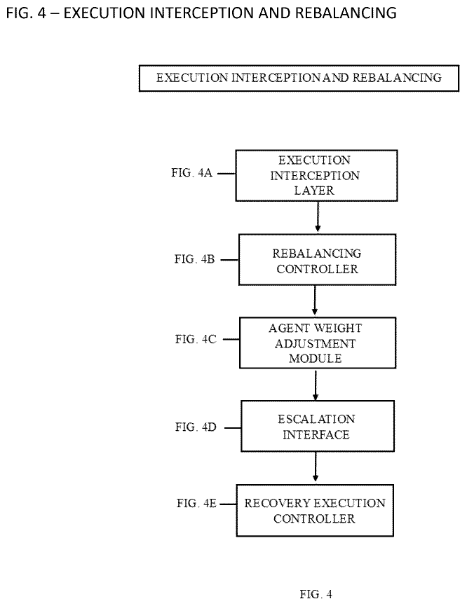

### FIG. 4—Execution Interception and Rebalancing

FIG. 4 illustrates interception and rebalancing when diversity constraints are not satisfied. Execution is halted prior to completion. Rebalancing restores acceptable diversity.

### FIG. 4A—Execution Interception Layer

FIG. 4A shows a layer that intercepts execution when constraints fail. Interception prevents irreversible actions. Intercepted results are rerouted.

### FIG. 4B—Rebalancing Controller

FIG. 4B illustrates a controller that initiates rebalancing operations. Influence weights are recalibrated. Modified inputs are re-evaluated.

### FIG. 4C—Agent Weight Adjustment Module

FIG. 4C depicts a module that adjusts agent weights. Dominant or correlated agents are reduced. Balance is restored.

### FIG. 4D—Escalation Interface

FIG. 4D illustrates an interface enabling supervisory or human escalation. Escalation occurs when automated rebalancing fails. Decisions are recorded.

### FIG. 4E—Recovery Execution Controller

FIG. 4E shows a controller that executes recovered consensus outputs. Recovery ensures system continuity. All recovery actions are tracked.

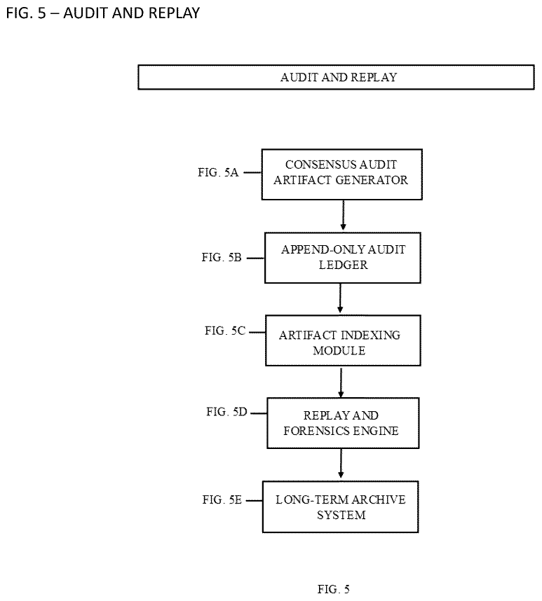

### FIG. 5—Audit and Replay

FIG. 5 illustrates generation and management of audit artifacts for consensus decisions. Artifacts provide deterministic replay capability. System behavior is transparently recorded.

### FIG. 5A—Consensus Audit Artifact Generator

FIG. 5A depicts a generator that produces consensus audit artifacts. Artifacts capture agent outputs, correlations, weights, and outcomes. Generated artifacts are authoritative records.

### FIG. 5B—Append-Only Audit Ledger

FIG. 5B illustrates an append-only ledger storing audit artifacts. The ledger prevents retroactive modification. Historical integrity is preserved.

### FIG. 5C—Artifact Indexing Module

FIG. 5C shows indexing of audit artifacts for retrieval. Indexing supports efficient access. Artifacts remain immutable.

### FIG. 5D—Replay and Forensics Engine

FIG. 5D illustrates replay of consensus decisions using stored artifacts. Replay reconstructs system state at execution time. Forensic analysis is supported.

### FIG. 5E—Long-Term Archive System

FIG. 5E depicts long-term storage of audit artifacts. Archives support retention requirements. Stored data remains accessible.

### Illustrative Operational Example (Non-Limiting)

In one illustrative example, a plurality of agents generate candidate outputs for a collective decision. Correlation metrics are computed across the outputs, and a herding signal is generated when similarity exceeds a violation threshold. Influence weights are dynamically adjusted prior to aggregation.

The aggregated result is evaluated by a consensus gate. If diversity constraints are satisfied, execution proceeds; otherwise, execution is intercepted and rebalancing continues. A consensus audit artifact is generated and stored for replay and verification.

1. A collective artificial intelligence system comprising a plurality of agents, a correlation analysis engine, an influence weighting engine, and a consensus gate configured to control execution of aggregated results.

2. A method for mitigating herding in a collective artificial intelligence system comprising detecting correlated behavior, adjusting influence weights prior to aggregation, and controlling execution through a consensus gate.

3. A non-transitory computer-readable medium storing instructions that cause a system to perform execution-time anti-herding enforcement.

4. The system of claim 1, wherein correlation metrics include similarity metrics.

5. The system of claim 1, wherein influence weights are dynamically recalculated.

6. The method of claim 2, further comprising generating a consensus audit artifact.

7. The method of claim 2, wherein execution is intercepted prior to completion.

8. The system of claim 1, wherein consensus audit artifacts are stored in an append-only ledger.

9. The medium of claim 3, wherein replay reconstructs execution state.

10. The system of claim 1, wherein diversity constraints are evaluated continuously.
